(19) United States
(12) Patent Application Publication
(10) Pub. No.: US 2026/0057258 A1
(43) Pub. Date: Feb. 26, 2026

(54) Systems and methods for generating a knowledge base

(71) Applicant: Virtusa Corporation, Southborough, MA (US)

(72) Inventors: Inderjeet Singh Aidhi, Hyderabad (IN); Khamarutheen Kottur Abdurlazak, Chennai (IN); Lourdu Jerald B, Chennai (IN)

(21) Appl. No.: 19/307,790

(22) Filed: Aug. 22, 2025

(30) Foreign Application Priority Data
Aug. 26, 2024 (IN) 202411064231

(51) Int. Cl. G06N 5/022; G06F 16/25; G06F 40/284; G06F 40/295

(52) U.S. Cl. CPC G06N 5/022; G06F 16/258; G06F 40/284; G06F 40/295

(57) ABSTRACT

Systems and methods for autonomously generating a knowledge base. The methods include receiving at an interface a plurality of content items containing natural language text, and applying natural language processing, using one or more processors executing instructions stored on memory, to the received plurality of content items to determine a structure of each of the plurality of content items and meaning of each of the plurality of content items to determine a prompt for a language model. The methods further include identifying, by supplying the prompt to the language model, at least one of a problem description associated with one or more of the plurality of content items, a troubleshooting step associated with one or more of the plurality of content items, or a resolution associated with one or more of the plurality of content items; and incorporating the identified problem description, troubleshooting step, or resolution into a knowledge base article using a knowledge base template specifying a format for generating the knowledge base article.

### CROSS REFERENCE TO RELATED APPLICATIONS

The present application claims the benefit of and priority to Indian Provisional Application no. 202411064231, filed on Aug. 26, 2024, the entire content of which is hereby incorporated by reference as if set forth in its entirety herein.

### TECHNICAL FIELD

Embodiments described herein generally relate to systems and methods for processing content items and, more specifically but not exclusively, to systems and methods for generating a knowledge base.

### BACKGROUND

A knowledge base may refer to a data repository accessed to solve a user-submitted problem. For example, a user may provide a problem statement, and a system or person may reference a knowledge base to identify a possible solution based on the problem statement.

Creating knowledge bases is generally a manual process. To create a knowledge base, analysts typically gather documents, analyze information associated with these documents, and create a knowledge base comprising articles for subsequent access to address a problem.

These manual-based approaches can be time consuming, prone to errors, and lead to inconsistencies. Additionally, analysts may struggle to keep pace with the continuously-growing volume of data.

Existing technologies have attempted to address these disadvantages. For example, ticket systems such as those provided by SERVICENOW® of Santa Clara, California enable users to store incident reports and solutions. However, creating well-structured knowledge bases is still a manual process.

Although machine learning models can summarize text, they often lack the ability to determine actionable solutions needed for knowledge base articles. While natural language processing techniques and their associated libraries can analyze text, building a comprehensive system requires additional development and integration beyond the capabilities of these tools.

Accordingly, there is a need for systems and methods that can overcome the disadvantages of existing techniques.

### SUMMARY

This summary is provided to introduce a selection of concepts in a simplified form that are further described below in the Detailed Description section. This summary is not intended to identify or exclude key features or essential features of the claimed subject matter, nor is it intended to be used as an aid in determining the scope of the claimed subject matter.

According to one aspect, embodiments relate to a method for autonomously generating a knowledge base. The method includes receiving at an interface a plurality of content items containing natural language text; applying natural language processing, using one or more processors executing instructions stored on memory, to the received plurality of content items to determine a structure of each of the plurality of content items and meaning of each of the plurality of content items to determine a prompt for a language model; identifying, by supplying the prompt to the language model, at least one of a problem description associated with one or more of the plurality of content items, a troubleshooting step associated with one or more of the plurality of content items, a resolution associated with one or more of the plurality of content items; and incorporating the identified problem description, troubleshooting step, or resolution into a knowledge base article using a knowledge base template specifying a format for generating the knowledge base article.

In some embodiments, each of the plurality of content items is an email, a ticketing report, or data from a user portal.

In some embodiments, using the knowledge base template comprises identifying pertinent data and non-pertinent data in the plurality of content items, removing the non-pertinent data so that the non-pertinent data is not included in the knowledge base article, and formatting the pertinent data into a consistent structure specified by the template.

In some embodiments, the method further includes updating the prompt through a prompt engineering process to generate an optimized prompt for identifying the problem description, troubleshooting step, or resolution.

In some embodiments, incorporating the identified problem description, troubleshooting step, or resolution comprises automatically populating the generated knowledge base article into an integrated Information Technology Service Management (ITSM) platform, thereby providing updated and actionable data to the ITSM platform.

In some embodiments, the knowledge base includes text, imagery, or code portions.

In some embodiments, applying the natural language processing includes executing a tokenization procedure and executing a named entity recognition procedure.

According to another aspect, embodiments relate to a system for autonomously generating a knowledge base. The system includes an interface for receiving a plurality of content items containing natural language text; and one or more processors executing instructions stored on memory to: apply natural language processing to the received plurality of content items to determine a structure of each of the plurality of content items and meaning of each of the plurality of content items to determine a prompt for a language model, identify, by supplying the prompt to the language model, at least one of: a problem description associated with one or more of the plurality of content items, a troubleshooting step associated with one or more of the plurality of content items, or a resolution associated with one or more of the plurality of content items; and incorporate the identified problem description, troubleshooting step, or resolution into a knowledge base article using a knowledge base template specifying a format for generating the knowledge base article.

In some embodiments, each of the plurality of content items is an email, a ticketing report, or data from a user portal.

In some embodiments, the one or more processors use the knowledge base template to identify pertinent data and non-pertinent data in the plurality of content items, remove the non-pertinent data so that the non-pertinent data is not included in the knowledge base article, and formatting the pertinent data into a consistent structure specified by the template.

In some embodiments, the one or more processors are further configured to update the prompt through a prompt engineering process to generate an optimized prompt for identifying the problem description, troubleshooting step, or resolution.

In some embodiments, incorporating the identified problem description, troubleshooting step, or resolution comprises automatically populating the generated knowledge base into an integrated Information Technology Service Management (ITSM) platform, thereby providing updated and actionable data to the ITSM platform.

In some embodiments, the knowledge base includes text, imagery, or code portions.

In some embodiments, the one or more processors process the received plurality of content items by executing a tokenization procedure and by executing a named entity recognition procedure.

According to yet another aspect, embodiments relate to a computer program product for autonomously generating a knowledge base. The computer program product comprises computer executable code embodied in one or more non-transitory computer readable media that, when executing on one or more processors, performs the steps of receiving at an interface a plurality of content items containing natural language text; applying natural language processing, using one or more processors executing instructions stored on memory, to the received plurality of content items to determine a structure of each of the plurality of content items and meaning of each of the plurality of content items to determine a prompt for a language model; identifying, by supplying the prompt to the language model, at least one of a problem description associated with one or more of the plurality of content items, a troubleshooting step associated with one or more of the plurality of content items, or a resolution associated with one or more of the plurality of content items, and incorporating the identified problem description, troubleshooting step, or resolution into a knowledge base article using a knowledge base template specifying a format for generating the knowledge base article.

In some embodiments, each of the plurality of content items is an email, a ticketing report, or a user portal.

In some embodiments, the computer program product further includes computer executable code that, when executing on one or more processors, performs the steps of identifying pertinent data and non-pertinent data in the plurality of content items, removing the non-pertinent data so that the non-pertinent data is not included in the knowledge base article, and formatting the pertinent data into a consistent structure specified by the template.

In some embodiments, the computer program product further includes computer executable code that, when executing on one or more processors, performs the step of updating the prompt through a prompt engineering process to generate an optimized prompt for extracting the problem description, troubleshooting step, or resolution.

In some embodiments, incorporating the identified problem description, troubleshooting step, or resolution comprises automatically populating the generated knowledge base into an integrated Information Technology Service Management (ITSM) platform, thereby providing updated and actionable data to the ITSM platform.

In some embodiments, the knowledge base includes text, imagery, or code portions.

### BRIEF DESCRIPTION OF DRAWINGS

Non-limiting and non-exhaustive embodiments of the invention are described with reference to the following figures, wherein like reference numerals refer to like parts throughout the various views unless otherwise specified.

FIG. 1 illustrates a system for generating a knowledge base in accordance with one embodiment;

FIG. 2 illustrates the prompt engineering module of FIG. 1 in accordance with one embodiment; and

FIG. 3 depicts a flowchart of a method for generating a knowledge base in accordance with one embodiment.

### DETAILED DESCRIPTION

Various embodiments are described more fully below with reference to the accompanying drawings, which form a part hereof, and which show specific exemplary embodiments. However, the concepts of the present disclosure may be implemented in many different forms and should not be construed as limited to the embodiments set forth herein; rather, these embodiments are provided as part of a thorough and complete disclosure, to fully convey the scope of the concepts, techniques and implementations of the present disclosure to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Reference in the specification to “one embodiment” or to “an embodiment” means that a particular feature, structure, or characteristic described in connection with the embodiments is included in at least one example implementation or technique in accordance with the present disclosure. The appearances of the phrase “in one embodiment” in various places in the specification are not necessarily all referring to the same embodiment. The appearances of the phrase “in some embodiments” in various places in the specification are not necessarily all referring to the same embodiments.

Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices. Portions of the present disclosure include processes and instructions that may be embodied in software, firmware or hardware, and when embodied in software, may be downloaded to reside on and be operated from different platforms used by a variety of operating systems.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including standard hard drives, solid state storage, floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each may be coupled to a computer system bus. Furthermore, the computers referred to in the specification may include a single processor or may be architectures employing multiple processor designs for increased computing capability.

A computer system (standalone, client or server computer system) configured by an application may constitute a “subsystem” that is configured and operated to perform certain operations. In one embodiment, the “subsystem” may be implemented mechanically or electronically, so a subsystem may comprise dedicated circuitry or logic that is permanently configured (within a special-purpose processor) to perform certain operations. In another embodiment, a “subsystem” may also comprise programmable logic or circuitry (as encompassed within a general-purpose processor or other programmable processor) that is temporarily configured by software to perform certain operations.

Accordingly, the term “subsystem” should be understood to encompass a tangible entity, be that an entity that is physically constructed permanently configured (hardwired) or temporarily configured (programmed) to operate in a certain manner and/or to perform certain operations described herein.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

Reference will now be made in detail to the exemplary embodiments, examples of which are illustrated in the accompanying drawings. Wherever possible, the same reference numbers will be used throughout the drawings to refer to the same or like parts.

Embodiments described herein provide novel techniques for generating a knowledge base. The described embodiments go beyond existing techniques involving just text recognition. Instead, the systems and methods described herein provide a comprehensive solution that automates knowledge base creation based on the context of content items.

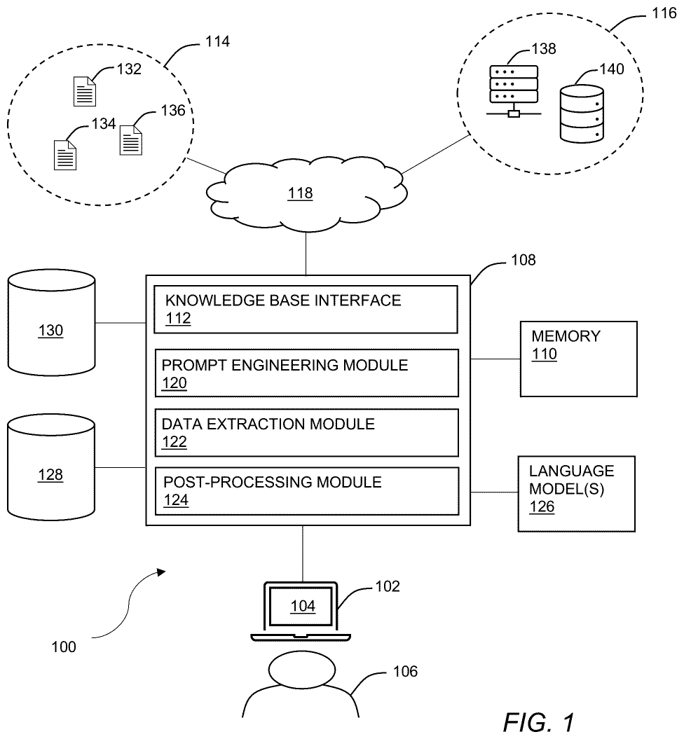

FIG. 1 illustrates a system 100 for generating a knowledge base in accordance with one embodiment. The system 100 may include a user device 102 executing a user interface 104 accessible by a user 106. The user device 102 may include an input/output (I/O) device such as, but not limited to, a laptop, PC, tablet, smartphone, smartwatch, or any other type of device that can execute the user interface 104 to allow the user 106 to provide or otherwise select data for generating a knowledge base.

The user interface 104 may allow the user 106 to provide instructions regarding the creation of a knowledge base. For example, the user 106 may select sources from which the system 100 can receive content items and how often. Similarly, the user interface 104 may allow the user 106 to manually provide content items for knowledge base article creation. In some embodiments, the user interface 104 may implement or otherwise rely on the Streamlit Python library and framework.

The user 106 may be an administrator associated with an enterprise network and tasked with selecting content items for generating a knowledge base. For example, the user 106 may want to create a knowledge base that comprises results from incident reports, ticketing items, emails or other types of electronic messages, or other document sources.

The processor(s) 108 may be any hardware device capable of executing instructions stored on memory 110 to provide various components or modules. The processor 108 may include a microprocessor, a field programmable gate array (FPGA), an application-specific integrated circuit (ASIC), or other similar devices.

In some embodiments, such as those relying on one or more ASICs, the functionality described as being provided in part via software may instead be configured into the design of the ASICs and, as such, the associated software may be omitted. The processor 108 may be configured as part of the user device 102 (e.g., a laptop) or located at some remote location.

The memory 110 may be L1, L2, L3 cache, or RAM memory configurations. The memory 110 may include non-volatile memory such as flash memory, EPROM, EEPROM, ROM, and PROM, or volatile memory such as static or dynamic RAM, as discussed above. The exact configuration or type of memory 110 may vary as long as instructions for generating a knowledge base can be performed by the system 100.

The system 100 may include a knowledge base interface 112 to receive data from content sources 114 and 116 over one or more networks 118. The processor 108 may also include or otherwise execute a prompt engineering module 120, a data extraction module 122, and a post-processing module 124.

The processor 108 may also be in communication with one or more language models 126 and one or more databases 128. The databases 128 may store templates regarding a particular user's 106 preferences for creating knowledge bases or articles thereof. For example, the templates may specify a corporate entity's preferences regarding format or structure of their knowledge base articles.

The network(s) 118 may link the various components with various types of network connections. The network(s) 118 may be comprised of, or may interface to, any one or more of the Internet, an intranet, a Personal Area Network (PAN), a Local Area Network (LAN), a Wide Area Network (WAN), a Metropolitan Area Network (MAN), a storage area network (SAN), a frame relay connection, an Advanced Intelligent Network (AIN) connection, a synchronous optical network (SONET) connection, a digital T1, T3, E1, or E3 line, a Digital Data Service (DDS) connection, a Digital Subscriber Line (DSL) connection, an Ethernet connection, an Integrated Services Digital Network (ISDN) line, a dial-up port such as a V.90, a V.34, or a V.34bis analog modem connection, a cable modem, an Asynchronous Transfer Mode (ATM) connection, a Fiber Distributed Data Interface (FDDI) connection, a Copper Distributed Data Interface (CDDI) connection, or an optical/DWDM network.

The network or networks 118 may also comprise, include, or interface to any one or more of a Wireless Application Protocol (WAP) link, a Wi-Fi link, a microwave link, a General Packet Radio Service (GPRS) link, a Global System for Mobile Communication (GSM) link, a Code Division Multiple Access (CDMA) link, or a Time Division Multiple access (TDMA) link such as a cellular phone channel, a Global Positioning System (GPS) link, a cellular digital packet data (CDPD) link, a Research in Motion, Limited (RIM) duplex paging type device, a Bluetooth radio link, or an IEEE 802.11-based link.

Content source group 114 may refer to an individual content source group and may comprise a plurality of individual content items. These may include, but are not limited to, work notes 132 by employees of a corporate entity, mail threads 134 (e.g., emails), or short-message-service (SMS) messages 136 between employees.

Content source group 116 may refer a bulk content source group and may comprise a plurality of bulk content items. These may include, but are not limited to, internal queues 138 or ticket files 140. For example, the ticket files 140 may refer to archived tickets from an IT Service Management (“ITSM”) Tool. These content items may relate to or include documentation regarding resolved incidents or uploads of other document sources. In addition to or in lieu of these content item sources, the user 106 may manually provide content items via the user interface 104. The system 100 may also be in communication with other types of tools, such as internal Wikipages, documentation from Atlassian's CONFLUENCE® platform, or any other type of tool or documentation type whether available now or invented hereafter.

In operation, the user 106 may provide some input with respect to the user interface 104 to create a knowledge base. For example, the user 106 may be an administrator associated with a corporate entity and tasked with creating a knowledge base 130 that can provide actionable solutions and relevant information for user-or customer-submitted requests.

In addition to or in lieu of receiving a request from the user 106, the system 100 may be configured to autonomously retrieve content items from the sources 114 and 116. In some embodiments, the knowledge base interface 112 may retrieve content items from the content sources 114 and 116 at predetermined intervals such as hourly, at the end of each day, at the end of each week, or the like. Accordingly, the knowledge base 130 may be continuously expanded and improved based on the receipt of new content items.

The knowledge base interface 112 may be implemented via the FastAPI Python web framework. The knowledge base interface 112 may refer to a representational state transfer (RESTful) interface that can use Hypertext Transfer Protocol (HTTP) functions such GET, POST, or DELETE to intake or process data from the content sources 114 and 116. In some embodiments, there may be designated APIs for each content source 114 and 116.

The prompt engineering module 120 may be tasked with generating prompts that can assist the language model(s) 126 for creating quality and helpful outputs. User-submitted prompts are often incomplete or do not include specific types of information that would be helpful in formulating a response. The prompt engineering module 120 may generate prompts that can receive as input an incomplete problem statement or prompt, build out the prompt to include more detail about the type of data or response the user desires, and instructions for the language model(s) for returning a helpful response.

The prompt engineering module 120 may rely on the language model(s) 126 to execute natural language processing techniques on the content items to determine a structure of the content item(s) and meaning of the content item(s). Accordingly, the prompt engineering module 120 module may obtain a deeper level of understanding of the words, strings, or characters within the content items.

In the context of the present application, the term “structure” as applied to content items may refer to how the content items are organized. For example, the structure of a particular type of content item may indicate that a first paragraph of a content item may refer to a question or problem statement, and subsequent paragraphs may refer to an answer or otherwise a resolution. As another example, the structure may refer to the organization of a content item based on its hierarchical structure or schema. In some embodiments, the structure may be determined at least in part based on HyperText Markup Language (HTML) tags.

In the context of the present application, the term “meaning” as applied to content items may refer to the definition of individual words included in the content items, as well as the overall intention of a word or group of words. For example, the meaning of a string of words may include an identification of the words as presenting a question, as well as the actual desired information in response to the question.

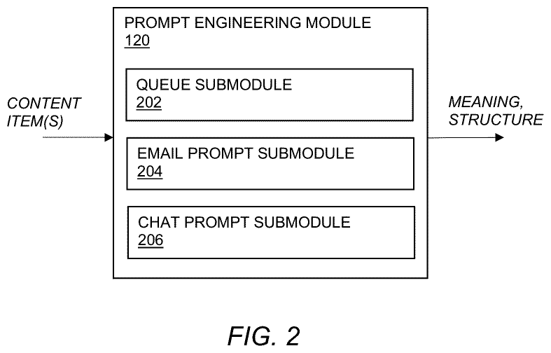

FIG. 2 illustrates the prompt engineering module 120 in accordance with one embodiment. The prompt engineering module 120 may execute, without limitation, a queue submodule 202, an email prompt module 204, and a chat prompt submodule 206. The queue submodule 202 may be configured to generate prompts specific to queue-based content items. The email prompt module 204 may be configured to generate prompts specific to email-based content items. The chat prompt submodule 206 may be configured to generate prompts specific to chat messages or SMS-based content items.

The prompt engineering module 120 may implement one or more of a variety of types of prompt engineering techniques. These may include, but are not limited to, self-refine prompting, directional-stimulus prompting, Maieutic prompting, complexity-based prompting, least-to-most prompting, generated knowledge prompting, tree-of-thought prompting, chain-of-thought prompting, or some combination thereof. These techniques are only exemplary and other types of prompt engineering techniques, whether available now or invented hereafter, may be implemented by the prompt engineering module 120 for generating a prompt.

The generated prompt may be communicated to one or language models 126. The language model(s) 126 may identify at least one of a problem description associated with one or more of the plurality of content items, a troubleshooting step associated with one or more of the plurality of content items, or a resolution associated with one or more of the plurality of content items.

The language model(s) 126 may implement natural language processing techniques such as, but not limited to, named entity recognition (NER), keyword extraction, tokenization, stemming and lemmatization, stop words removal, part-of-speech tagging, Term Frequency-Inverse Document Frequency (TF-IDF), or some combination thereof. These natural language processing techniques are only exemplary, and other techniques whether available now or invented hereafter may be used to accomplish the features of the described embodiments.

The data extraction module 122 may be configured to extract various types of data from text data to identify information that is relevant to knowledge base articles. This type of data may include, but is not limited to, a problem description, troubleshooting step(s), source or author of the text (as permitted by any privacy requirements), testimonials regarding troubleshooting steps, and resolution details.

A problem description may refer to a problem described in one of the content items. For example, a particular content item may be a request from an employee for assistance regarding a problem they are having with their computer. The identified problem description in this situation may refer to the employee's problem (e.g., their computer routinely freezes), along with accompanying data such as how long the problem has occurred, how often the problem occurs, the type of computer the employee is using, etc.

A troubleshooting step may refer to one or more actions taken to address a problem. These steps may have initially been suggested by an administrator or otherwise someone tasked with helping employees address certain types of problems. In the example above, a troubleshooting step may be for the employee to “upgrade software,” or “restart computer.” In some embodiments, a content item may have a “troubleshooting step” field, the value for which is a troubleshooting step taken or at least recommended.

A resolution step may refer to how a problem was resolved. For example, a content item with a problem may frequently include a resolution that specifies which actions or troubleshooting steps were successful in addressing the problem. In some embodiments, only one of several troubleshooting steps may have been successful in addressing a problem. Accordingly, in these instances, a resolution may refer to the troubleshooting step that was most successful in addressing a problem. These metrics may be based on user testimonials, such as how many people found a troubleshooting step successful. In some embodiments, a content item may have a “resolution”field, the value for which is a resolution.

The output of the data extraction module 122 may be communicated to the post-processing module 124. The post-processing module 124 may be configured to clean the received text data before it is stored in the knowledge base 130. For example, the post-processing module 124 may remove irrelevant conversational elements from text data. Irrelevant conversational elements may include greetings, salutations, punctuation, or other types of data that is unnecessary for a knowledge base article.

The post-processing module 124 may also reference the database 128 for any stored template(s) regarding the user 106. Templates may specify the desired format of articles as well as other article characteristics required by the user 106 or their employer. These templates may specify the desired layout of knowledge base articles, whether certain types of data should or should not be included in a knowledge base article, or other types of user-or customer-specified requirements for articles. The templates may specify whether and how knowledge base articles should present data structures such as tables, graphs, charts, or the like. Similarly, the templates may allow an article to include text, imagery, code snippets, etc.

The system 100, now with at least one of a problem description, troubleshooting step, resolution, and template, can generate the articles for storage in the knowledge base 130. The knowledge base 130 may be associated with a particular company and relate to a particular topic, for example. These articles may be leveraged in future instances, such as when an employee submits a query or request for a resolution.

In some embodiments, the user 106 may provide feedback regarding the generated knowledge base and articles therein. The system may further include a feedback integration module (not shown in FIG. 1), that may consider user feedback to refine data extraction rules, improve article structure, prioritize or schedule article updates, etc.

The disclosed embodiments may be implemented in variety of applications. For example, the embodiments herein may be implemented for analyzing emails, documents, internal data, and then for automatically generating structured and consistent knowledge base articles.

In telecommunications-based applications, for example, the embodiments herein can process network incident reports as well as engineering notes. The embodiments herein can create a knowledge base for solving problems faster and improving service uptime. Similarly, in this type of application, the embodiments herein may integrate with customer support systems for generating knowledge base articles from frequently asked questions and troubleshooting guides. This allows the described embodiments to resolve customer inquiries more efficiently and without requiring human support.

As another example, the described embodiments may help generate knowledge base articles relating to insurance policies. This ensures agents have the latest plan details and are up to date with the latest regulations. Additionally, the embodiments herein may leverage notes from claims adjusters and historical data to provide clear guidelines for processing claims. This may ensure consistency in processing claims.

As yet another example, the described embodiments may be implemented in entertainment-based industries. For example, the embodiments herein may provide a centralized knowledge base of artistic content for content creators, editors, marketing teams, or the like. This knowledge base can ensure consistent brand messaging and production quality.

As yet another example, the embodiments herein may process user manuals, product specifications, bug reports, and developer documentation. The processing of these documents may help populate a comprehensive knowledge base to enable faster product troubleshooting and improved customer support. Similarly, the embodiments herein may capture knowledge from engineers, product managers, and security teams to provide this knowledge base and foster collaboration across departments.

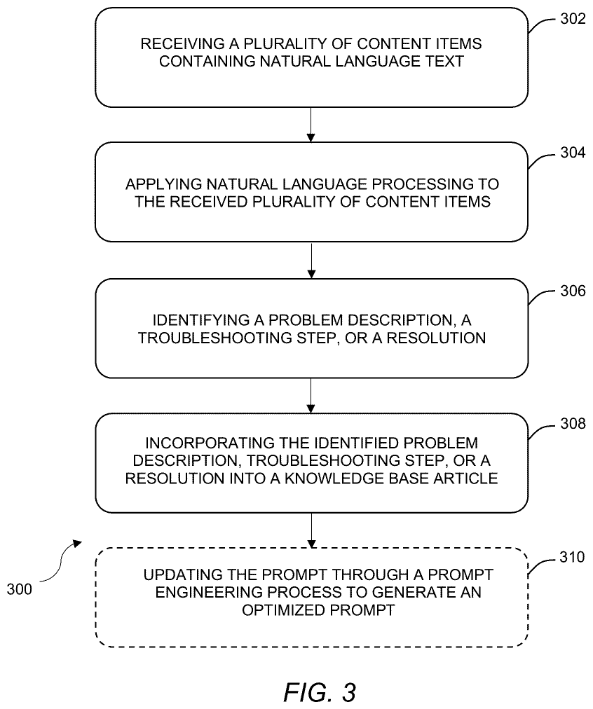

FIG. 3 depicts a flowchart of a method 300 for autonomously generating a knowledge base in accordance with one embodiment. The system 100 of FIG. 1 or the components thereof may perform one or more of the steps of FIG. 3.

Step 302 involves receiving at an interface a plurality of content items containing natural language text. These content items may be from a variety of content sources, and may be received at an interface such as the knowledge base interface 112 at certain time intervals, when requested by a user, etc.

Step 304 involves applying natural language processing, using one or more processors executing instructions stored on memory, to the received plurality of content items. The natural language processing techniques may determine a structure of each of the plurality of content items and meaning of each of the plurality of content items to determine a prompt for a language model.

Step 306 involves identifying, by supplying the prompt to the language model, at least one of a problem description associated with one or more of the plurality of content items, a troubleshooting step associated with one or more of the plurality of content items, or a resolution associated with one or more of the plurality of content items. The language model may execute one or more of a variety of natural language techniques to identify these features associated with the content items.

Step 308 involves incorporating the identified problem description, troubleshooting step, or resolution into a knowledge base article using a knowledge base template specifying a format for generating the knowledge base article. The template may be provided by a user or customer and specify various requirements, desired formats, or other characteristics

Step 310 is optional and involves updating the prompt through a prompt engineering process to generate an optimized prompt for identifying the problem description, troubleshooting step, or resolution. The method 300 may be iterated until the system 100 generates an optimized prompt. Updates to the prompt may also be based on user-provided feedback to a generated prompt.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Embodiments of the present disclosure, for example, are described above with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, or alternatively, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

A statement that a value exceeds (or is more than) a first threshold value is equivalent to a statement that the value meets or exceeds a second threshold value that is slightly greater than the first threshold value, e.g., the second threshold value being one value higher than the first threshold value in the resolution of a relevant system. A statement that a value is less than (or is within) a first threshold value is equivalent to a statement that the value is less than or equal to a second threshold value that is slightly lower than the first threshold value, e.g., the second threshold value being one value lower than the first threshold value in the resolution of the relevant system.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of various implementations or techniques of the present disclosure. The systems and methods involving hardware and software and/or functional parts therefore may be physically integrated into or housed inside or attached to another device, be it an imaging device, a stimulus or electrophysiological recording device, and patient audio device, etc. Also, a number of steps may be undertaken before, during, or after the above elements are considered.

Having been provided with the description and illustration of the present application, one skilled in the art may envision variations, modifications, and alternate embodiments falling within the general inventive concept discussed in this application that do not depart from the scope of the following claims.

What is claimed is:

1. A method for autonomously generating a knowledge base, the method comprising:
receiving at an interface a plurality of content items containing natural language text;
applying natural language processing, using one or more processors executing instructions stored on memory, to the received plurality of content items to determine a structure of each of the plurality of content items and meaning of each of the plurality of content items to determine a prompt for a language model;
identifying, by supplying the prompt to the language model, at least one of:
a problem description associated with one or more of the plurality of content items,
a troubleshooting step associated with one or more of the plurality of content items, or
a resolution associated with one or more of the plurality of content items; and
incorporating the identified problem description, troubleshooting step, or resolution into a knowledge base article using a knowledge base template specifying a format for generating the knowledge base article.

2. The method of claim 1 wherein each of the plurality of content items is an email, a ticketing report, or data from a user portal.

3. The method of claim 1 wherein using the knowledge base template comprises:
identifying pertinent data and non-pertinent data in the plurality of content items;
removing the non-pertinent data so that the non-pertinent data is not included in the knowledge base article; and
formatting the pertinent data into a consistent structure specified by the template.

4. The method of claim 1 further comprising updating the prompt through a prompt engineering process to generate an optimized prompt for identifying the problem description, troubleshooting step, or resolution.

5. The method of claim 1 wherein incorporating the identified problem description, troubleshooting step, or resolution comprises automatically populating the generated knowledge base article into an integrated Information Technology Service Management (ITSM) platform, thereby providing updated and actionable data to the ITSM platform.

6. The method of claim 1 wherein the knowledge base includes text, imagery, or code portions.

7. The method of claim 1 wherein applying the natural language processing includes:
executing a tokenization procedure, and
executing a named entity recognition procedure.

8. A system for autonomously generating a knowledge base, the system comprising:
an interface for receiving a plurality of content items containing natural language text, and
one or more processors executing instructions stored on memory to:
apply natural language processing to the received plurality of content items to determine a structure of each of the plurality of content items and meaning of each of the plurality of content items to determine a prompt for a language model,
identify, by supplying the prompt to the language model, at least one of:
a problem description associated with one or more of the plurality of content items,
a troubleshooting step associated with one or more of the plurality of content items, or
a resolution associated with one or more of the plurality of content items; and
incorporate the identified problem description, troubleshooting step, or resolution into a knowledge base article using a knowledge base template specifying a format for generating the knowledge base article.

9. The system of claim 8 wherein each of the plurality of content items is an email, a ticketing report, or data from a user portal.

10. The system of claim 8 wherein the one or more processors use the knowledge base template to:
identify pertinent data and non-pertinent data in the plurality of content items;
remove the non-pertinent data so that the non-pertinent data is not included in the knowledge base article; and
formatting the pertinent data into a consistent structure specified by the template.

11. The system of claim 8 wherein the one or more processors are further configured to update the prompt through a prompt engineering process to generate an optimized prompt for identifying the problem description, troubleshooting step, or resolution.

12. The system of claim 8 wherein incorporating the identified problem description, troubleshooting step, or resolution comprises automatically populating the generated knowledge base into an integrated Information Technology Service Management (ITSM) platform, thereby providing updated and actionable data to the ITSM platform.

13. The system of claim 8 wherein the knowledge base includes text, imagery, or code portions.

14. The system of claim 8 wherein the one or more processors process the received plurality of content items by executing a tokenization procedure and by executing a named entity recognition procedure.

15. A computer program product for autonomously generating a knowledge base, the computer program product comprising computer executable code embodied in one or more non-transitory computer readable media that, when executing on one or more processors, performs the steps of:
receiving at an interface a plurality of content items containing natural language text;
applying natural language processing, using one or more processors executing instructions stored on memory, to the received plurality of content items to determine a structure of each of the plurality of content items and meaning of each of the plurality of content items to determine a prompt for a language model;
identifying, by supplying the prompt to the language model, at least one of:
a problem description associated with one or more of the plurality of content items,
a troubleshooting step associated with one or more of the plurality of content items, or
a resolution associated with one or more of the plurality of content items; and
incorporating the identified problem description, troubleshooting step, or resolution into a knowledge base article using a knowledge base template specifying a format for generating the knowledge base article.

16. The computer program product of claim 15 wherein each of the plurality of content items is an email, a ticketing report, or a user portal.

17. The computer program product of claim 15, further comprising computer executable code that, when executing on one or more processors, performs the steps of:
identifying pertinent data and non-pertinent data in the plurality of content items;
removing the non-pertinent data so that the non-pertinent data is not included in the knowledge base article; and
formatting the pertinent data into a consistent structure specified by the template.

18. The computer program product of claim 15 further comprising computer executable code that, when executing on one or more processors, performs the step of updating the prompt through a prompt engineering process to generate an optimized prompt for extracting the problem description, troubleshooting step, or resolution.

19. The computer program product of claim 15 wherein incorporating the identified problem description, troubleshooting step, or resolution comprises automatically populating the generated knowledge base into an integrated Information Technology Service Management (ITSM) platform, thereby providing updated and actionable data to the ITSM platform.

20. The computer program product of claim 15 wherein the knowledge base includes text, imagery, or code portions.
